(19) United States
(12) Patent Application Publication
(10) Pub. No.: US 2024/0414072 A1
(43) Pub. Date: Dec. 12, 2024

(54) Session Continuity Support for New Radio Quality of Experience

(71) Applicant: Apple Inc., CUPERTINO, CA (US)

(72) Inventors: Pavan NUGGEHALLI, San Carlos, CA (US); Alexander SIROTKIN, Hod Hasharon (IL); Fangli XU, Beijing (CN); Haijing HU, Los Gatos, CA (US); Naveen Kumar R PALLE VENKATA, San Diego, CA (US); Ralf ROSSBACH, Munich (DE); Sarma V VANGALA, Campbell, CA (US); Sethuraman GURUMOORTHY, San Ramon, CA (US); Yuqin CHEN, Beijing (CN); Zhibin WU, Los Altos, CA (US)

(21) Appl. No.: 18/702,466

(22) PCT Filed: Oct. 21, 2021
(86) PCT No.: PCT/CN2021/125307

§ 371 Date: Apr. 18, 2024

(51) Int. Cl. H04L 41/5067; H04W 28/06; H04W 48/04; H04W 76/20

(52) U.S. Cl. CPC H04L 41/5067; H04W 28/06; H04W 48/04; H04W 76/20

(57) ABSTRACT

A user equipment (UE) is configured to receive a quality of experience (QoE) measurement configuration for performing QoE measurements, wherein the QoE measurement configuration includes at least one QoE measurement session, receive a QoE measurement deactivation command including an indication as to whether the QoE measurements are deactivated based on a geographical area scope restriction and based on the indication, determine whether to promptly deactivate the QoE measurements or to deactivate the QoE measurements when an active measurement session has ended.

### TECHNICAL FIELD

The present disclosure relates to communication, in particular, to Session continuity support for new radio quality of experience.

### BACKGROUND INFORMATION

Quality of experience (QoE) measurements may be used to analyze the performance of a service/application from the perspective of a user equipment (UE). QoE measurements are configured for the UE by the operations, administration and maintenance (OAM) domain of the core network, e.g., the 5G-Core (5GC) of a 5G New Radio (NR) radio access technology (RAT). The UE may be configured to generate the QoE measurements in the application/higher layers, encapsulate the measurements in a transparent container, and transmit the encapsulated measurements to a receiving entity of the 5GC via the 5G NR radio access network (RAN).

### SUMMARY

Some exemplary embodiments are related to a processor of a user equipment (UE) configured to perform operations. The operations include receiving a quality of experience (QoE) measurement configuration for performing QoE measurements, wherein the QoE measurement configuration includes at least one QoE measurement session, receiving a QoE measurement deactivation command including an indication as to whether the QoE measurements are deactivated based on a geographical area scope restriction and, based on the indication, determining whether to promptly deactivate the QoE measurements or to deactivate the QoE measurements when an active measurement session has ended.

Other exemplary embodiments are related to a processor of a base station configured to perform operations. The operations include determining that a user equipment (UE) configured for performing quality of experience (QoE) measurements has moved to a location where a geographical area scope restriction is imposed for the QoE measurements and transmitting a QoE measurement deactivation command to the UE including an indication the QoE measurements are deactivated based on the geographical area scope restriction.

Still further exemplary embodiments are related to a processor of a base station configured to perform operations. The operations include receiving a quality of experience (QoE) measurement deactivation command from a core network entity or an operations, administration and maintenance (OAM) domain to deactivate a QoE measurement configuration for a user equipment (UE) and transmitting the QoE measurement deactivation command to the UE in a transparent container including an indication the QoE measurements are deactivated based on a request from the core network entity.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary network cell according to various exemplary embodiments.

FIG. 4a shows a signaling diagram for QoE measurement deactivation based on an out-of-area condition according to various exemplary embodiments described herein.

FIG. 4b shows a signaling diagram for QoE measurement deactivation based on OAM request according to various exemplary embodiments described herein.

FIG. 5 shows a method for performing QoE measurements at a UE according to various exemplary embodiments described herein.

FIG. 6 shows an exemplary information element (IE) for an OtherConfig field of an RRCReconfiguration comprising an areaOutOfScope parameter according to various exemplary embodiments described herein.

### DETAILED DESCRIPTION

The exemplary embodiments may be further understood with reference to the following description and the related appended drawings, wherein like elements are provided with the same reference numerals. The exemplary embodiments describe operations for deactivating a quality of experience (QoE) measurement configuration for a user equipment (UE). According to some aspects, a QoE measurement release/deactivation command is received by the UE indicating a cause for the release. If the UE is currently performing QoE measurements in an ongoing measurement session, the UE determines, based on the cause, whether to deactivate the QoE measurements prior to the end of the session or to wait until the session ends. According to some aspects, the cause for the deactivation command may indicate the UE has moved out of the area scope for the QoE measurements or that the core network has initiated the deactivation, to be described in detail below.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) network. However, reference to a 5G NR network is merely provided for illustrative purposes. The exemplary embodiments may be utilized with any network implementing a quality of experience (QoE) architecture similar to that described herein. Therefore, the 5G NR network as described herein may represent any type of network implementing similar QoE functionalities as the 5G NR network.

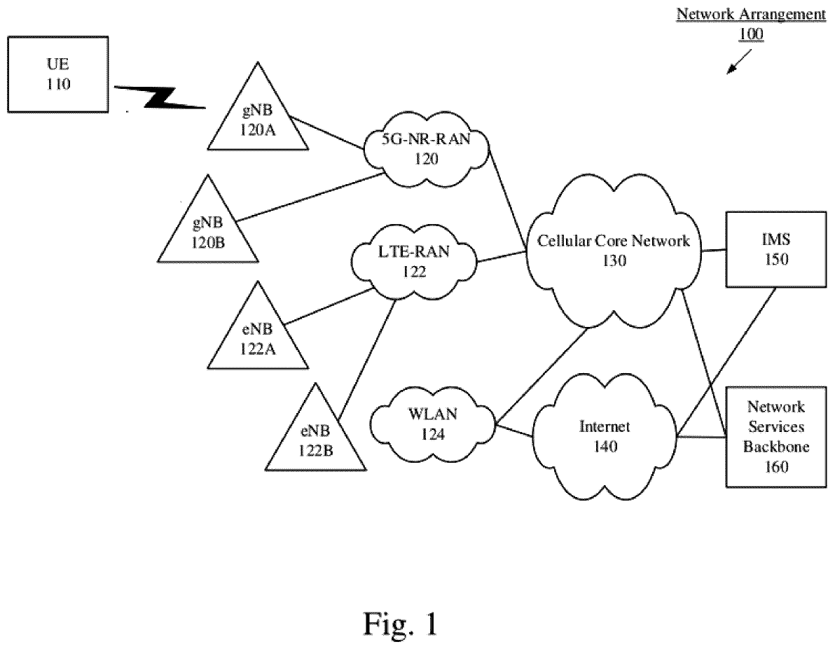

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to two gNBs 120A, 120B is merely for illustrative purposes. The exemplary embodiments may apply to any appropriate number of gNBs. In some embodiments, a handover may be performed for the UE 110 by a source gNB, e.g., gNB 120A, to a target gNB, e.g., gNB 120B.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. According to some embodiments, the core network 130 is the 5G-Core (5GC) of the 5G NR radio access technology (RAT). The core network 130 may include an operations, administration and maintenance (OAM) domain, which refers to the processes and functions used in managing and maintaining the network or network elements. As will be described in greater detail below, the OAM may transmit activation/deactivation commands to the 5G NR-RAN 120 to configure QoE measurements for the UE 110. The core network 130 may additionally include a measurement collection entity (MCE) and/or a trace collection entity (TCE) for receiving measurements reports from the 5G NR-RAN 120, e.g., QoE measurement reports generated by the UE 110.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

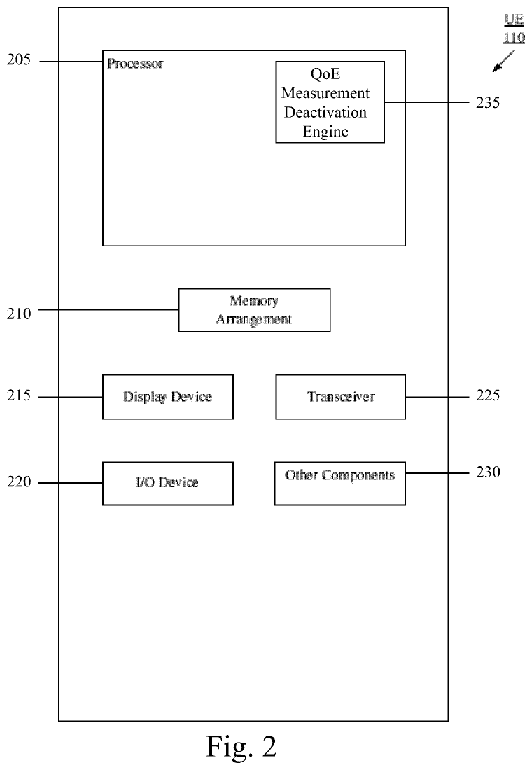

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a QoE measurement deactivation engine 235. The QoE measurement deactivation engine 235 may perform operations including receiving a QoE measurement deactivation command from a base station and determining whether to deactivate a QoE measurement configuration prior to the end of a current (active) session, or to deactivate the QoE measurement configuration once the current session ends. The QoE measurement deactivation engine 235 may also receive indications from the higher layers of the UE 110 regarding the start and end of a current session, wherein the QoE measurement deactivation engine 235 maintains a current QoE measurement state in accordance therewith (e.g., current session is active or no current session is active) and may base the determination of when to deactivate the QoE measurement configuration on the current QoE measurement state. The specific implementations for these QoE measurement deactivation scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

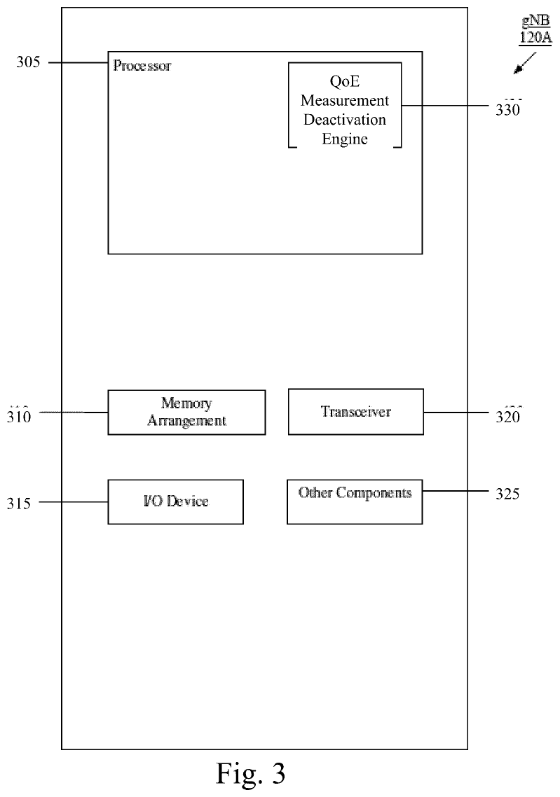

FIG. 3 shows an exemplary network cell, in this case gNB 120A, according to various exemplary embodiments. As noted above with regard to the UE 110, the gNB 120A may represent a serving cell for the UE 110. The gNB 120A may represent any access node of the 5G NR network through which the UEs 110 may establish a connection and manage network operations. The gNB 120A illustrated in FIG. 3 may also represent the gNB 120B.

The gNB 120A may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a QoE measurement deactivation engine 330. The QoE measurement deactivation engine 330 may perform operations including transmitting a QoE measurement deactivation command to a UE. According to some aspects, the gNB 120A may indicate in the deactivation command a cause for the deactivation command. For example, the cause may indicate the UE has moved out of the area scope for the QoE measurements or that the core network (e.g., OAM) has initiated the deactivation of the QoE measurements. In some embodiments, the gNB 120A is a source gNB performing a handover for the UE to a target gNB, and the deactivation command is initiated by the source gNB and delivered to the UE via the target gNB. In other embodiments, the gNB 120A receives a deactivation command initiated by the core network, e.g., the OAM domain of the core network. The specific implementations for these measurement deactivation scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UEs 110, 112 and any other UE in the system 100, e.g., if the gNB 120A serves as a PCell or an SCell to either or both of the UEs 110, 112. The transceiver 325 may operate on a variety of different frequencies or channels (e.g., set of consecutive frequencies). Therefore, the transceiver 325 may include one or more components (e.g., radios) to enable the data exchange with the various networks and UEs.

Quality of experience (QoE) in NR is a Rel-17 feature enabling the collection of application layer (AL) measurements from a user equipment (UE), for example with respect to streaming, Multimedia Telephone Service for IMS (MTSI), and virtual reality (VR) services accessed by the UE. QoE measurements may be configured by the operations, administration and maintenance (OAM) domain of the core network, e.g., the 5GC. The OAM refers to the processes and functions used in managing and maintaining the network or network elements.

The QoE configuration may be specified according to the QoE measurement collection (QMC) functionality. According to existing QMC methodologies, the QoE measurement configuration command for the application (APP) layer (AL) of the UE is initiated by the OAM and transmitted to a gNB, which encapsulates the QoE measurement configuration command in a transparent container (e.g., an RRCReconfiguration container) and transmits the encapsulated configuration command to the UE in an RRCReconfiguration message. The RRCReconfiguration message may include an otherConfig parameter including, e.g., a parameter for activating QoE measurements (measConfigAppLayerToAddList) and/or a parameter for deactivating QoE measurements (measConfigApplayerToReleaseList). The UE generates the QoE measurements in the higher layers (e.g., AL) and submits the measurements to the UE access stratum (AS), which encapsulates the measurements in a transparent container and transmits the encapsulated measurements to the gNB in a MeasurementReportAppLayer message. The gNB may then forward the measurements to a measurement collection entity (MCE) and/or a trace collection entity (TCE) of the core network.

The QoE measurement configuration may include multiple measurement sessions performed at various intervals by the AL. The AL may submit multiple measurement reports to the AS layer during an active measurement session.

To disable the AL measurements, the OAM may transmit a QoE measurement release/deactivation command to the UE. Upon reception of the QoE measurement release command, the UE AS may discard unsent QoE reports and inform the higher layers (e.g., AL) of the released/deactivated QoE measurement configuration.

In addition to the activation/deactivation methodology discussed above, QoE measurements may be activated/deactivated based on a geographic area scope. In this scenario, QoE measurements may be restricted for a UE when the UE is outside a configured geographic area and allowed for the UE when the UE is inside the configured geographic area. For example, it is specified that for streaming and MTSI sessions, the UE should not start any new QoE measurement sessions if the UE falls outside the configured geographic area. However, for active measurement sessions, QoE measurements should not be halted until the end of the session even if the UE moves out of the configured area. It is further specified that this area scope management is implemented by the radio access network (RAN) (e.g., 5G NR-RAN 120), rather than the UE. The RAN is responsible for determining whether the UE is inside or outside the geographic area scope, and configures or releases the QoE measurements accordingly.

During a UE handover from a source gNB to a target gNB that supports QoE, the target gNB may decide which QoE configurations to keep and which to release, e.g., based on QoE configuration information received from the source gNB in an RRC container via Xn/Ng signaling. It is noted that the QMC configuration release can be used by the gNB to stop QoE measurement collection and reporting, even in the middle of an application session.

In view of the QoE measurement requirements discussed above, a conflict exists between the area scope management requirements and the maintenance of session continuity requirements, particularly in the handover scenario discussed above. For example, in this scenario, the UE is first configured with QoE measurements in the source gNB which satisfies the area scope requirement. While camped to the source gNB, a session starts in the UE for which the QoE measurement applies. The UE is then handed over to the target gNB, which does not satisfy the area scope requirement. The target gNB releases the QoE configuration, as per the QoE restriction for area scope management. The UE then releases the QoE configuration for an active session, which violates the session continuity requirement that specifies that the UE is to continue an ongoing measurement session even after the UE falls outside the area scope. Thus, in the above scenario, it must be ensured that QoE measurements are not released prematurely by the target gNB.

A solution may be for the UE may send session start notifications and session end notifications to the gNB when the UE begins/ends a QoE measurement session. In the handover scenario the source gNB, being informed of the ongoing session, can indicate the session status for each QoE configuration to the target gNB during handover. The target gNB can then refrain from releasing the QoE configuration for an ongoing session, even if the area scope requirement is not fulfilled.

However, the above solution raises various issues. A first issue is excessive signaling, wherein the UE would be required to send a message every time a session starts or ends. A second issue is information leakage, wherein the RAN (and potentially, other eavesdroppers) can become aware of which kind of services a UE is running, how long the sessions last, etc. This kind of “meta” information could be considered private, and eavesdroppers could, for example, fingerprint users based on their usage pattern. A third issue is gNB complexity, wherein the gNB is required to maintain a session ‘state’ for each session for each UE. A fourth issue is UE complexity, wherein attention (AT) commands are needed for the UE APP layer to indicate session start/stop to UE AS layer. Accordingly, it may be preferable to manage session continuity and area scope management for QoE measurements without explicit session start/stop indications from the UE to the network.

According to various exemplary embodiments described herein, an indication may be included in a QoE measurement deactivation command transmitted from a gNB to a UE to indicate to the UE a reason for the AL measurement release. For example, the release may be requested by the core network (e.g., the OAM) or may be initiated by the RAN (e.g., gNB) due to the UE moving out of the geographical area scope.

According to some aspects of the exemplary embodiments, when a gNB releases/deactivates a particular QoE configuration, it informs the UE if the release was requested by the core network (e.g., OAM) or requested by the RAN (e.g., gNB) due to the UE moving out of area scope. When the deactivation command is initiated by the gNB based on area scope, the gNB may transmit an RRCReconfiguration to the UE including an indication that the deactivation command is based on an out-of-area condition. When the deactivation command is initiated by the OAM, the gNB may transmit an RRCReconfiguration to the UE including an indication that the deactivation command is not based on an out-of-area condition. For example, in some embodiments, a parameter comprising a single bit may indicate whether the out-of-area condition is true or false. When the condition is false, it may be assumed that the deactivation command was initiated by the OAM. In other embodiments, a greater number of bits may be used for indicating additional causes for the deactivation of the QoE measurements.

In one aspect, during handover, either the source gNB or the target gNB may check whether the area scope requirement is fulfilled. The source gNB may provide a QoE measurement configuration for the UE to the target gNB in a handover request, and the target gNB may check the area scope for the QoE measurement configuration prior to transmitting a handover request acknowledgment. If the handover request acknowledgment indicates the out-of-area condition, then the target gNB may initiate an RRCReconfiguration command for deactivating the QoE measurement configuration, including an indication for the out-of-area condition, and transmit the command to the source gNB for transmission to the UE. This indication may be a single bit, wherein the out-of-area condition is set to ‘true.’ In other embodiments, the source gNB may check whether the area scope requirement is fulfilled for the UE at the target gNB, and initiate appropriate action, such as not providing the QoE measurement configuration to the target gNB.

In another aspect, in any scenario (including the handover scenario), a serving gNB for the UE may receive a deactivation command for the UE from the core network (e.g., OAM). The serving gNB receives the deactivation command and encapsulates the command in a transparent container that includes an indication for the OAM-initiated deactivation condition. As discussed above, this indication may be a single bit wherein the out-of-area condition is set to ‘false.’

The UE, upon receiving the deactivation command, checks the indication to determine whether the deactivation is due to the out-of-area condition or not. If the UE has a currently active QoE measurement session, and the indication indicates the out-of-area condition, then the UE does not deactivate the QoE measurements until the session ends. If the UE does not have a currently active QoE measurement session, and the indication indicates the out-of-area condition, then the UE promptly deactivates the QoE measurements. If the indication does not indicate the out-of-area condition (e.g., the indication indicates that core network deactivation), then the UE promptly deactivates the QoE measurements, regardless of whether the UE has a currently active QoE measurement session or not.

The AS layer and the higher layers (e.g., AL) of the UE communicate so that the AS layer knows whether a current QoE measurement session is ongoing. Thus, the AS layer of the UE may maintain a ‘state’ regarding whether a current QoE measurement session is active. The higher layers (e.g., AL) of the UE may indicate to the AS layer of the UE when a session starts and when a session ends, and the AS layer may adjust its QoE measurement session state based on the indications from the AL.

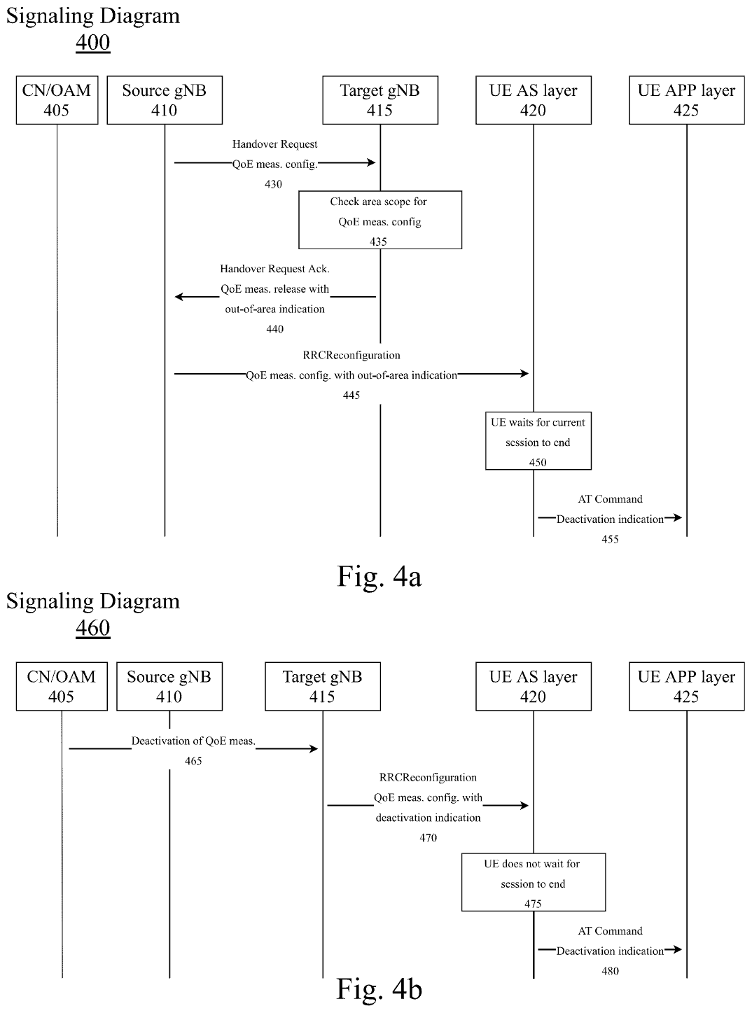

FIG. 4a shows a signaling diagram 400 for QoE measurement deactivation based on an out-of-area condition according to various exemplary embodiments described herein. The signaling diagram 400 is described with respect to a handover scenario and includes the core network (e.g., OAM) 405, a source gNB 410 and a target gNB 415 for a UE. The UE is shown in the diagram 400 as comprising an AS layer 420 for communicating with the network and an APP layer 425 for performing the QoE measurements.

In 430, the source gNB 410 transmits a handover request for the UE to the target gNB 415. The handover request includes an indication of a current QoE measurement configuration for the UE.

In 435, the target gNB 415 checks the area scope requirement for the UE for the configured QoE measurements. In this example, the target gNB 415 determines that the UE is out of the area scope for QoE measurements.

In 440, the target gNB 415 transmits a handover request acknowledgment to the source gNB 410. The handover request acknowledgment includes an indication that the UE is out of the area scope for QoE measurements.

In 445, the target gNB 415 transmits a QoE measurement deactivation command to the UE (e.g., an RRCReconfiguration) including an indication indicating the out-of-area condition. The deactivation command is transmitted via the source gNB 410, which encapsulates the command in a transparent container prior to transmission to the UE.

In the example of FIG. 4a, the target gNB 415 is the gNB that checks whether the area scope requirement is satisfied. However, in other embodiments, the source gNB 410 may check the area scope requirement, and initiate the deactivation command without first receiving an out-of-area indication from the target gNB 415.

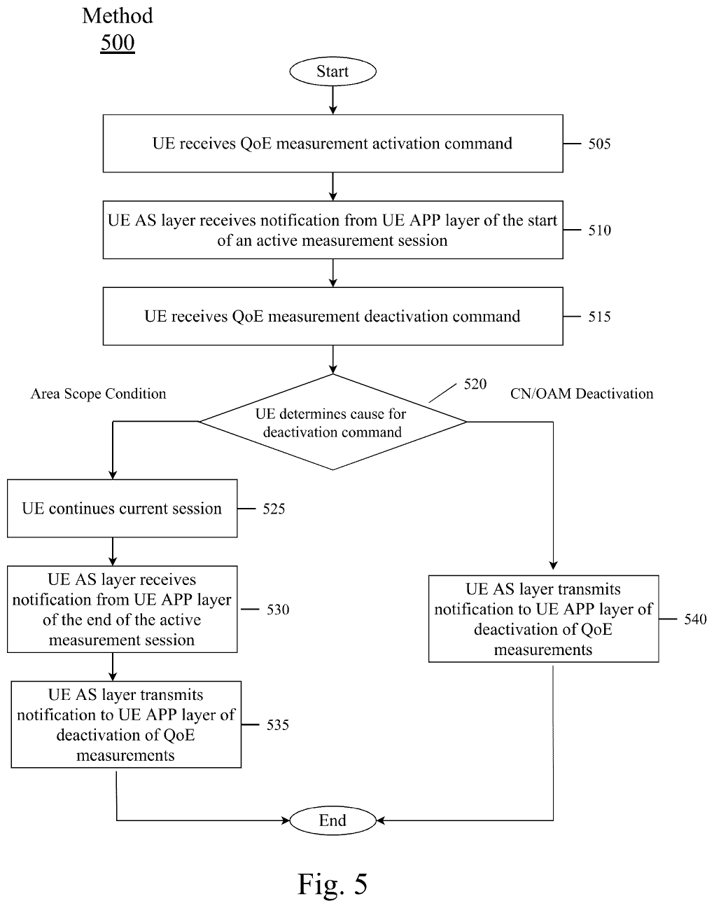

In 450, the UE AS layer 420 processes the deactivation command and determines the cause for the deactivation is due to the out-of-area condition. When the UE APP layer 425 has a currently active QoE measurement session, then the AS layer 420 waits until the current session ends before informing the APP layer 425 of the QoE measurement deactivation. Thus, until the active session ends, the AS layer 420 continues transmitting QoE measurement reports received from the APP layer 425 to the network. The UE behavior for this deactivation scenario will be described in further detail below with respect to FIG. 5.

In 455, when the current QoE measurement session ends, the AS layer 420 indicates the deactivation to the APP layer 425 and the QoE measurement configuration is deactivated.

As shown in FIG. 4a, the CN/OAM 405 is not involved in the deactivation of the QoE measurement configuration for the UE based on area scope. As discussed above, the RAN is responsible for checking the area scope requirement and initiates the QoE measurement deactivation without any input from the CN/OAM 405.

FIG. 4b shows a signaling diagram 460 for QoE measurement deactivation based on OAM request according to various exemplary embodiments described herein. The signaling diagram 460, similar to the signaling diagram 400, is described with respect to a handover scenario and includes the core network (e.g., OAM) 405, a source gNB 410 and a target gNB 415 for a UE. However, the signaling diagram 460 may apply to any scenario where a UE is served by a gNB and is not specific to the handover scenario. The UE is shown in the diagram 460 as comprising an AS layer 420 for communicating with the network and an APP layer 425 for performing the QoE measurements.

In 465, the CN/OAM 405 transmits a QoE measurement configuration for the UE to a serving gNB of the UE, in this example the target gNB 415. The QoE measurement configuration indicates the deactivation of the current QoE measurement configuration for the UE.

In 470, the target gNB 415 transmits a QoE measurement deactivation command to the UE (e.g., an RRCReconfiguration) including an indication indicating the OAM deactivation condition. The deactivation command received from the CN/OAM 405 is encapsulated in a transparent container for transmission to the UE.

In 475, the UE AS layer 420 processes the deactivation command and determines the cause for the deactivation is due to the OAM deactivation condition. Regardless of whether the UE APP layer 425 has a currently active QoE measurement session, the AS layer 420 promptly indicates the deactivation to the APP layer 425 and the QoE measurement configuration is deactivated. The AS layer 420 may discard any unsent measurement reports received from the APP layer 425.

As discussed above, for the UE AS layer to know whether a current measurement session is ongoing at the APP layer, an indication from the APP layer may be used to signal the start/stop of a session. The AS layer may maintain a current QoE measurement state per QoE configuration, e.g., current session active or no current session active, based on the indications from the APP layer.

FIG. 5 shows a method 500 for performing QoE measurements at a UE according to various exemplary embodiments described herein.

In 505, the UE receives a QoE measurement activation command, e.g., an RRCReconfiguration message, including an application layer (AL) measurement configuration. The QoE measurement configuration is initiated by the core network (e.g., OAM), and a serving gNB encapsulates the RRCReconfiguration message in a transparent container for transmission to the UE. The AS layer of the UE passes the configuration to the higher layers, e.g., the APP layer. As discussed above, when the QoE measurement configuration is passed to the higher layers, the AS layer may maintain a session state for the QoE configuration. Prior to receiving a notification from the APP layer of the start of a measurement session, the session state for AS layer may comprise no current session is active.

In 510, the UE AS layer receives a notification of the start of a measurement session. The notification may comprise an AT command. Upon receiving the indication from the APP layer, the AS layer may maintain a session state (e.g., current session ongoing) for the current QoE measurement session. During an ongoing session, the AS layer may receive measurements from the APP layer, encapsulate the measurements, and send the encapsulated measurements to the gNB, which forwards the measurements to the OAM. The QoE session may last some duration e.g., X seconds and comprise multiple measurement reports.

In 515, during an ongoing measurement session, the UE receives a deactivation command, e.g., an RRCReconfiguration indicating the release of the QoE measurement configuration.

In 520, the UE processes an indication in the deactivation command and determines whether to deactivate the QoE measurements promptly or only after the current session ends.

In 525, if the indication indicates an area scope condition (and a measurement session is currently ongoing), the UE continues the current session until the APP layer informs the AS layer that the current session has ended. Thus, the UE continues to transmit QoE measurement reports received from the higher layers to the network.

In 530, the current session ends and the APP layer notifies the AS layer of the session ending. The notification may comprise an AT command. Upon receiving the notification of the session ending, in 535, the AS layer notifies the APP layer of the deactivation of the QoE measurements and the APP layer discontinues the measurements.

Returning to 520, the indication may not indicate an area scope condition. In one embodiment, the single bit for the area scope condition is set to false. In another embodiment, the indication may indicate OAM deactivation, or some other cause.

In 540, the UE does not wait for the end of the current measurement session and promptly sends a deactivation indication e.g., an AT command to the higher layers to deactivate the QoE measurements. The AS layer may discard any unsent measurement reports.

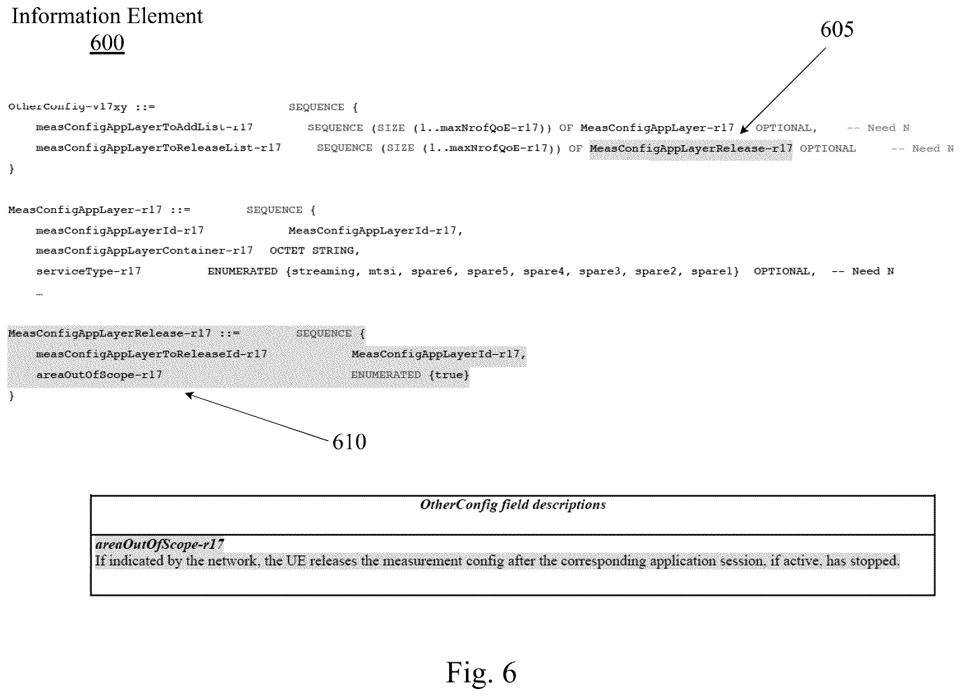

FIG. 6 shows an exemplary information element (IE) 600 for an OtherConfig field of an RRCReconfiguration comprising an areaOutOfScope parameter according to various exemplary embodiments described herein.

The OtherConfig includes a QoE measurement release field 605, e.g., MeasConfigAppLayerRelease-r17. The MeasConfigAppLayerRelease-r17 field includes an indication parameter 610, e.g., areaOutofScope. When the areaOutofScope parameter is indicated as ‘true’ by the network, the UE releases the QoE measurement configuration after an active measurement session has stopped.

The exemplary embodiments discussed above include various benefits, relative to an alternative solution where the UE informs the network of a session start/end. First, the network does not need to have any information about the sessions running at a UE, and thus there is reduced signaling when the indication solution is used. The indication solution additionally reduces the potential for eavesdroppers to track user session activity. Further, the network is not required to track the activity of UEs.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor configured to:
receiving a quality of experience (QoE) measurement configuration to perform QoE measurements, wherein the QoE measurement configuration includes at least one QoE measurement session;
receiving a QoE measurement deactivation command including an indication as to whether the QoE measurements are deactivated based on a geographical area scope restriction; and
based on the indication, determining whether to promptly deactivate the QoE measurements or to deactivate the QoE measurements when an active measurement session has ended.

2. The processor of claim 1, further configured to:
promptly deactivate the QoE measurements when the indication indicates the QoE measurement deactivation is initiated by a core network entity; and
deactivate the QoE measurements when the active measurement session has ended when the indication indicates the QoE measurement deactivation based on the geographical area scope restriction.

3. The processor of claim 1, further configured to:
maintain a session state for the QoE measurements, wherein the session state comprises a first state when a current QoE measurement session is active or a second state when the current QoE measurement session is not active.

4. The processor of claim 3, further configured to:
process, by an access stratum (AS) layer, a notification from an application layer (AL) that the current QoE measurement session has started or that the current QoE measurement session has ended; and
update the session state based on the notification.

5. The processor of claim 4, wherein the notification comprises an attention (AT) command.

6. The processor of claim 1, wherein, when the processor determines to promptly deactivate the QoE measurements, the processor is further configured to:
discard, by an access stratum (AS) layer, unsent QoE measurement reports; and
indicate, by the AS layer, the QoE measurement deactivation to an application layer (AL).

7. The processor of claim 1, wherein, when the processor determines to deactivate the QoE measurements when the active measurement session has ended, the processor is further configured to:
continue, by an access stratum (AS) layer, to transmit QoE measurement reports until receiving a notification from an application layer (AL) that the active measurement session has ended;
process, by the AS layer, the notification from the AL that the active measurement session has ended; and
indicate, by the AS layer, the QoE measurement deactivation to the AL.

8. The processor of claim 1, wherein the indication comprises an enumerated parameter.

9. The processor of claim 8, wherein, when the enumerated parameter is set to true, the indication indicates the QoE measurements are deactivated based on the geographical area scope restriction.

10. The processor of claim 8, wherein, when the enumerated parameter is set to false, the indication indicates the QoE measurements are deactivated based on a request from a core network entity.

11. The processor of claim 8, wherein the indication is included in an RRCReconfiguration message.

12. A processor configured to:
determine that a user equipment (UE) configured for performing quality of experience (QoE) measurements has moved to a location where a geographical area scope restriction is imposed for the QoE measurements; and
generate, for transmission to the UE, a QoE measurement deactivation command to the UE including an indication the QoE measurements are deactivated based on the geographical area scope restriction.

13. The processor of claim 12, wherein the indication is an enumerated parameter.

14. The processor of claim 13, wherein, when the enumerated parameter is set to true, the indication indicates the QoE measurements are deactivated based on the geographical area scope restriction.

15. The processor of claim 13, wherein the indication is included in an RRCReconfiguration message.

16. A processor configured to:
process, based on signals received from a core network entity or an operations, administration and maintenance (OAM) domain, a quality of experience (QoE) measurement deactivation command to deactivate a QoE measurement configuration for a user equipment (UE); and
generate for transmission to the UE, the QoE measurement deactivation command in a transparent container including an indication the QoE measurements are deactivated based on a request from the core network entity.

17. The processor of claim 16, wherein the indication is an enumerated parameter.

18. The processor of claim 17, wherein, when the enumerated parameter is set to false, the indication indicates the QoE measurements are deactivated based on the request from the core network entity.

19. The processor of claim 16, wherein the indication is included in an RRCReconfiguration message.
